(19) United States
(12) Patent Application Publication
(10) Pub. No.: US 2008/0261626 A1
(43) Pub. Date: Oct. 23, 2008

(54) Method and system for transmitting a location of a mobile communication device

(76) Inventor: Farshid Farazmandnia, Irvine, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/788,404

(22) Filed: Apr. 20, 2007

(51) Int. Cl. H04Q 7/22; G01S 1/00; H04Q 7/32; H04M 1/00

(52) U.S. Cl. 455/456.5; 342/357.1; 455/466; 455/556.2

(57) ABSTRACT

There is provided a method for use by a mobile communication device for transmitting a location of the mobile communication device over a network using a protocol stack. In one embodiment, location data indicating the location of the mobile communication device is received. The location data can include, for example, Global Positioning System (“GPS”) coordinates. Thereafter a command for initiating transmission of the location data is received from a user. Then a delivery destination is received from the user. The delivery destination can be, for example, a telephone number of a cellular telephone. The location data is then provided to the protocol stack. A Short Message Service (“SMS”) message including said location data is then generated. The SMS message is then transmitted to the delivery destination.

### BACKGROUND OF THE INVENTION

1. Field of the Invention

The present invention relates generally to mobile communication devices. More particularly, the present invention relates to enhancing the features of mobile communication devices.

2. Background Art

Many manufacturers of mobile communication devices, e.g., cellular telephones, are incorporating various geographic positioning systems, such as Global Positioning System (“GPS”) receivers, in their products to increase sales. More specifically, in the cellular telephone industry, a growing number of cellular telephone manufacturers are incorporating GPS receivers and other geographic positioning systems into their cellular telephones as part of the Enhanced 911 (also referred to as “E911”) rules set forth by the FCC. Thus, by the year 2008, it is anticipated that the majority of mobile communication devices available on the market will have geographic positioning capabilities.

However, the features and flexibility provided by mobile communication devices that are equipped with such geographic positioning systems are quite limited. For example, a user of a mobile communication device who wishes to communicate her location to another party must first determine her precise location (e.g., an address or GPS coordinates) using the mobile communication device or otherwise, and then must communicate her location to the other party by, for example, placing a call to the other party. Such an exchange of information can be very inconvenient and even unsafe when, for example, both parties are operating a motor vehicle. Furthermore, such an exchange of information may not even be possible if the user of the mobile communication device is unable to determine her precise location in the first place.

### SUMMARY OF THE INVENTION

There is provided methods and systems for transmitting a location of a mobile communication device, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a block diagram of a system for transmitting a location of a mobile communication device, in accordance with one embodiment of the invention;

FIG. 2 illustrates an example transmission of a location of a mobile communication device, in accordance with one embodiment of the invention; and

FIG. 3 illustrates a flowchart of a method for transmitting a location of a mobile communication device over a network using a protocol stack, in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

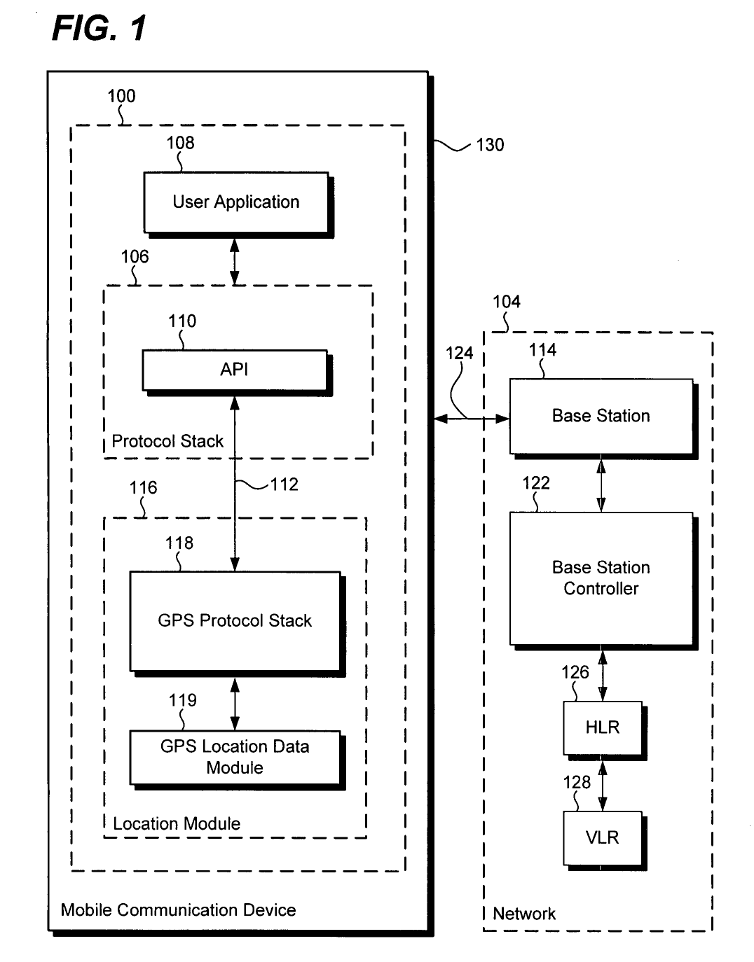

FIG. 1 shows a block diagram of system 100 for transmitting a location of a mobile communication device, in accordance with one embodiment of the invention. As shown in FIG. 1, system 100 is situated in mobile communication device 130 and includes user application 108, protocol stack 106, and location module 116. As also shown in FIG. 1, mobile communication device 130 is in communication with network 104 via data path 124. Mobile communication device 130 can be, for example, a cellular telephone, a personal digital assistant (“PDA”), or a laptop computer.

As shown in FIG. 1, user application 108 is in communication with protocol stack 106. User application 108 can be, for example, an embedded software application or user-installed software application. In one embodiment, user application 108 can include a user interface configured to receive data input by a user. Protocol stack 106 can include, for example, a number of protocols or “layers” (not shown in FIG. 1) that are known in the art, such as an application layer, a transport layer, a network layer, a link layer, and a physical layer.

As further shown in FIG. 1, protocol stack 106 further includes application protocol interface (“API”) 110, which is in communication with location module 116. Protocol stack 106 can be configured to be compatible with any one of a number of communication standards, such as Global System for Mobile Communications (“GSM”), General Packet Radio Service (“GPRS”), Code Division Multiple Access (“CDMA”), Wideband Code Division Multiple Access (“WCDMA”), Universal Mobile Telecommunications System (“UMTS”), or Enhanced Data rates for GSM Evolution (“EDGE”). As discussed below, protocol stack 106 can be utilized by mobile communication device 130 to communicate with network 104 over data path 124. Data path 124 can include, for example, one or more communication channels, such as a transmit channel, a dedicated channel, and a control channel.

Location module 116 shown in FIG. 1 can be configured to receive and to store location data, such as geographic coordinates, indicating the location of mobile communication device 130. In the embodiment shown in FIG. 1, location module 116 includes GPS protocol stack 118 and GPS location data module 119. GPS protocol stack 118 can include, for example, a management layer, a control layer, and an object driver layer (layers not shown in FIG. 1). In one embodiment, GPS location data module 119 can include a volatile or non-volatile memory device configured to receive and to store the current GPS coordinates of mobile communication device 130. As such, in one embodiment, mobile communication device 130 can include a GPS receiver (not shown in FIG. 1) which can be configured to determine the current GPS coordinates of mobile communication device 130. In such an embodiment, GPS location data module 119 can be configured to receive the GPS coordinates from the GPS receiver. Once received, the GPS coordinates can be provided to API 110 in protocol stack 106 through GPS protocol stack 118.

In another embodiment, location module 116 can be configured to receive location data generated by network 104, rather than using a GPS module. In the embodiment shown in FIG. 1, network 104 is a GSM network. In other embodiments of the invention, network 104 can be, for example, a GPRS network, a CDMA network, a WCDMA network, a UMTS network, or an EDGE network. As shown in FIG. 1, network 104 includes base station 114, base station controller 122, home location register (“HLR”) 126, and visitor location register (“VLR”) 128. Network 104 can be configured to determine the location of mobile communication device 130 utilizing HLR 126 and VLR 128, and can be further configured to generate location data that includes the location of mobile communication device 130. In one embodiment, the location data can be transmitted to mobile communication device 130 over data path 124 and can be received by location module 116.

In yet another embodiment, network 104 can be configured to determine the location of mobile communication device 130 using various radiolocation techniques known in the art, such as angle of arrival, time difference of arrival, or using location signature. Network 104 can be further configured to generate location data, which includes the determined location of mobile communication device 130. In one embodiment, the location data can be transmitted to mobile communication device 130 over data path 124 and can be received by location module 116.

Once the location data is received by location module 116, a transmitter of mobile communication device 130 can be configured to transmit the location data to a delivery destination specified by a user. The delivery destination can be, for example, a telephone number corresponding to a cellular telephone or a network address, such as an Internet Protocol (“IP”) address. The location data can be transmitted to the delivery destination using an appropriate protocol and communication channel in data path 124 described above. In one embodiment, the location data can be included in a Short Message Service (“SMS”) message (also referred to as a “text message”) generated by user application 108, which can be transmitted to the delivery destination through data path 124. For example, network 104 can be a GSM network and the SMS message can be transmitted to the delivery destination through a dedicated channel in data path 124. In another embodiment, the location data can be transmitted over either a control channel or a traffic channel in data path 124, or any other channel that can be utilized for communicating such information.

In one embodiment, user application 108 in mobile communication device 130 can include a command or a button, such as a “Find Me” command or button, for initiating a transmission of the location data to a delivery destination. In one embodiment, the “Find Me” command or pressing the “Find Me” button allows API 110 to retrieve the current location data, e.g., GPS coordinates, of mobile communication device 130 stored in location module 116. Thereafter, the user can be prompted for a delivery destination, e.g., a telephone number of a cellular telephone. Once the user has input the delivery destination, the location data can be transmitted to the delivery destination through network 104.

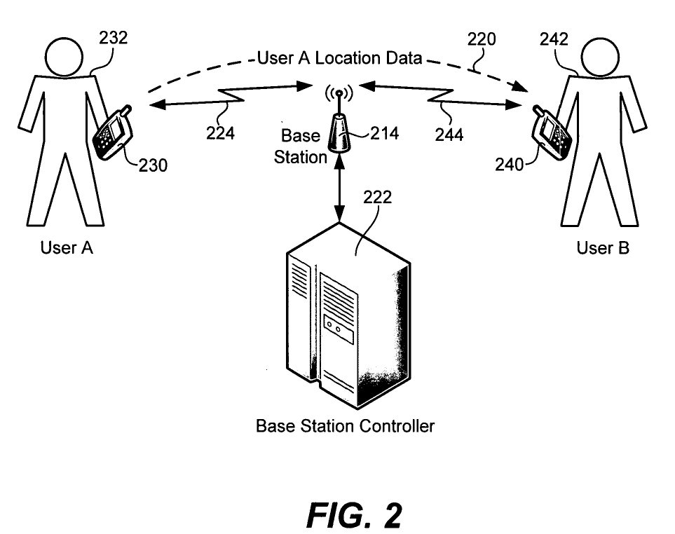

FIG. 2 illustrates an example transmission of a location of a mobile communication device in accordance with one embodiment of the invention. FIG. 2 includes sender 232 (also referred to as “user A”), mobile communication device 230, recipient 242 (also referred to as “user B”), mobile communication device 240, base station 214, and base station controller 222. As shown in FIG. 2, mobile communication devices 230 and 240 are in communication with base station 214 via data paths 224 and 244, respectively. In particular, mobile communication device 230, data path 224, base station 214, and base station controller 222 correspond to mobile communication device 130, data path 124, base station 114, and base station controller 122 in FIG. 1, respectively.

As shown in FIG. 2, user A can transmit her current location (i.e., the location of mobile communication device 230) to user B by executing the abovementioned “Find Me” command. In one embodiment, the “Find Me” command can be executed by pressing one or more buttons on mobile communication device 230. In another embodiment, user application 108 can include voice recognition software, thereby allowing a user to execute the “Find Me” command by saying the words “find me.” Thereafter, user A can be prompted to input a delivery destination. For example, user A can input the telephone number of mobile communication device 240. In one embodiment, user A can execute a “send” command to initiate the transmission of user A's location data to mobile communication device 240 of user B, as illustrated by arrow 220. In another embodiment, the transmission of user A's location data can begin automatically. As described above, the location data can be included in an SMS message, which can be advantageously accessed by user B either immediately or at a later time.

In one embodiment, mobile communication device 240 can include a mapping application, such as a GPS tracking application, which can be configured to display the location of mobile communication device 230 on a pre-installed map. In such an embodiment, the location data received from user A can be automatically input into the mapping application, thus advantageously allowing user B to avoid having to manually input the location of user A into the mapping application. The mapping application can be further configured, for example, to determine the shortest route from user B's location to user A's location, thus allowing user B to quickly and conveniently travel to user A's location. Furthermore, in one embodiment, if user A is on the move, user A's communication device may periodically determine the current location and transmit an updated location to user B's communication device. Even more, as user A and user B move, their communication devices may receive updated location information from each other and map out a path, which will provide an intersection point for user A and user B.

It should be understood that the example transmission of a location of a mobile communication device shown in FIG. 2 can be similarly performed using a General Packet Radio Service (“GPRS”) network, a Code Division Multiple Access (“CDMA”) network, a Wideband Code Division Multiple Access (“WCDMA”) network, a Universal Mobile Telecommunications System (“UMTS”) network, or an Enhanced Data rates for GSM Evolution (“EDGE”) network. Accordingly, system 100 described above can be modified to allow User A to send location data to User B using any one of the abovementioned networks without departing from the scope of the invention.

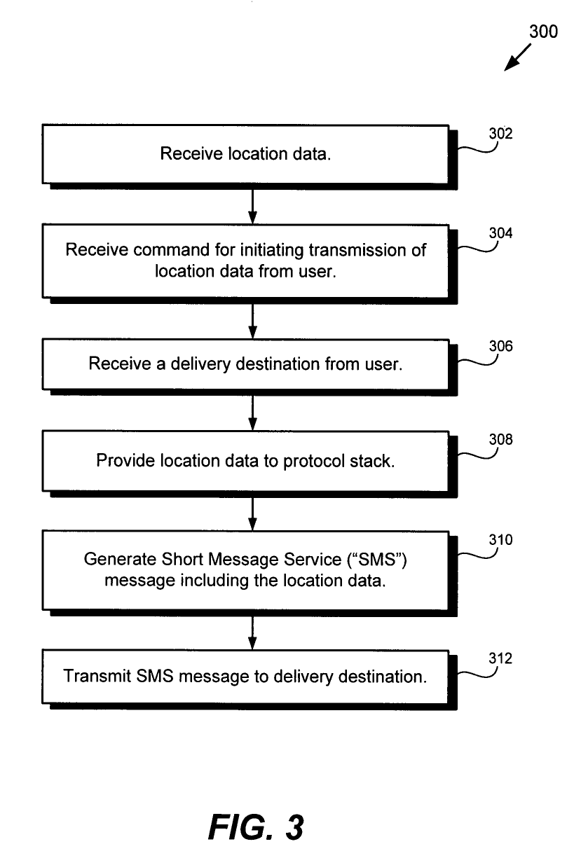

FIG. 3 illustrates flowchart 300 for performing an example method for transmitting a location of a mobile communication device over a network using a protocol stack. With reference to the embodiment shown in FIG. 1 and as shown in FIG. 3, at step 302 of flowchart 300, location data indicating the location of the mobile communication device is received by location module 116. At step 304, a command for initiating transmission of the location data is received from a user of the mobile communication device. Then, at step 306, a delivery destination is received from the user. At step 308, the location data is provided to the protocol stack. Thereafter, at step 310, a Short Message Service (“SMS”) message including the location data is generated. At step 312, the SMS message is transmitted to the delivery destination.

Therefore, the invention provides several important advantages. For example, the invention allows a user of a mobile communication device to transmit her location to a party, who may be looking for the user, even when the user is not able to determine her precise location. For example, a child who has become lost can utilize the invention to transmit her location to her guardian's mobile communication device, who can then easily locate the child using a mapping application as described above. Moreover, a user who is expecting to meet someone at a particular location can transmit her current location with safety and convenience, even when both parties are operating motor vehicles. Furthermore, since the invention uses infrastructures already in place, such as SMS messaging, and includes only minor modifications to the software of a mobile communication device, the invention can be implemented in a mobile communication device at a low cost.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a mobile communication device for transmitting a location of said mobile communication device over a network, said method comprising:
receiving location data, said location data indicating said location of said mobile communication device;
receiving a command from a user to initiate transmission of said location data;
receiving a delivery destination from said user;
transmitting said location data to said delivery destination.

2. The method of claim 1 further comprising providing said location data to a protocol stack of said mobile communication device after said receiving said location data.

3. The method of claim 1 further comprising generating a Short Message Service (“SMS”) message including said location data, wherein said transmitting said location data includes transmitting said SMS message.

4. The method of claim 3 wherein said transmitting said location data is performed by transmitting said SMS message.

5. The method of claim 1 wherein said mobile communication device is one of a cellular telephone, a personal digital assistant (“PDA”), or a laptop computer.

6. The method of claim 1 wherein said location data includes Global Positioning System (“GPS”) coordinates.

7. The method of claim 1 wherein said delivery destination is one of a telephone number or an Internet Protocol (“IP”) address.

8. The method of claim 1 wherein said network is one of a Global System for Mobile Communications (“GSM”) network, a General Packet Radio Service (“GPRS”) network, a Code Division Multiple Access (“CDMA”) network, a Wideband Code Division Multiple Access (“WCDMA”) network, a Universal Mobile Telecommunications System (“UMTS”) network, or an Enhanced Data rates for GSM Evolution (“EDGE”) network.

9. The method of claim 1 wherein said mobile communication device includes a location module configured to store said location data.

10. The method of claim 9 wherein said protocol stack includes an application protocol interface (“API”) in communication with said location module.

11. A mobile communication device for use over a network to communicate a location of a user of said mobile communication device, said mobile communication device comprising:
a protocol stack, said protocol stack including an application protocol interface (“API”);
a location module configured to receive location data indicating said location of said mobile communication device, said location module being in communication with said API;
a user interface configured to receive a delivery destination from a user; and
a transmitter configured to transmit said location data to said delivery destination.

12. The device of claim 11 further comprising a user application, said user application including a command for initiating transmission of said location data.

13. The device of claim 11 wherein said location data is included in a Short Message Service (“SMS”) message and wherein said transmitting includes transmitting said SMS message to said delivery destination.

14. The device of claim 11 wherein said location data is transmitted to said delivery destination through one of a control channel of said network, a dedicated channel of said network, or a traffic channel of said network.

15. The device of claim 11 wherein said mobile communication device is one of a cellular telephone, a personal digital assistant (“PDA”), or a laptop computer.

16. The device of claim 11 wherein said location data includes Global Positioning System (“GPS”) coordinates.

17. The device of claim 16 wherein said GPS coordinates are provided by a GPS receiver situated in said mobile communication device.

18. The device of claim 11 wherein said location data is provided by said network

19. The device of claim 11 wherein said delivery destination is one of a telephone number or an Internet Protocol (“IP”) address.

20. The device of claim 11 wherein said network is one of a Global System for Mobile Communications (“GSM”) network, a General Packet Radio Service (“GPRS”) network, a Code Division Multiple Access (“CDMA”) network, a Wideband Code Division Multiple Access (“WCDMA”), a Universal Mobile Telecommunications System (“UMTS”) network, or an Enhanced Data rates for GSM Evolution (“EDGE”) network.
